(19) United States
(12) Patent Application Publication
(10) Pub. No.: US 2018/0067462 A1
(43) Pub. Date: Mar. 8, 2018

(54) MODULAR BATCH DESIGN TOOL FOR BATCH ENGINEERING SYSTEMS

(71) Applicant: Honeywell International Inc., Morris Plains, NJ (US)

(72) Inventors: RAHUL DE, BANGALORE (IN); AVINASH RAJAN, BANGALORE (IN); KALYANASUNDARAM G, BANGALORE (IN)

(21) Appl. No.: 15/259,206

(22) Filed: Sep. 8, 2016

(51) Int. Cl. G05B 17/02; G05B 19/042

(52) U.S. Cl. CPC G05B 17/02; G05B 2219/35026; G05B 2219/35043; G05B 19/0426

(57) ABSTRACT

A method of batch system design for batch processes run by a batch processing system includes providing a piping and instrumentation diagram of the batch system and process write-ups of batch processes as inputs to a batch design tool. The algorithm processes the inputs along with modular batch design concepts and a compliant batch standard to derive batch engineering system designs including a first batch engineering system design compliant with the batch standard including a physical model and procedural model. The batch engineering system designs include function blocks for implementation. The first batch engineering system design is modified based on received customer' feedback by a system specific configuration generation block to generate system specific configurations in a form of master batch recipes, the function blocks and sequential function charts ladder logistics. The system specific configurations are processed to generate a customized batch engineering system design.

### FIELD

Disclosed embodiments relate to automating batch solutions in process industries that run a plurality of different product recipes for producing different products.

### BACKGROUND

Processing facilities are often managed using process control systems. Example processing facilities include manufacturing plants, chemical plants, crude oil refineries, and ore processing plants. Among other operations, process control systems typically manage the use of motors, valves, and other industrial equipment in the processing facilities.

In conventional process control systems, controllers are often used to control the operation of the industrial equipment in the processing facilities. The controllers could, for example, monitor and control the operation of the industrial equipment and generate alarms when malfunctions occur.

“Control processes” are often implemented in conventional controllers using “function blocks.” Control processes typically represent processes or functions implemented by the conventional controllers to control the industrial equipment in the processing facilities. Function blocks typically represent executable software objects that perform specific tasks. Any of a wide range of functions could be represented by the function blocks. A combination of particular function blocks may be used to implement a specific control process in a conventional controller.

Most batch plants face common challenges which include maximizing productivity from assets in use to meet demand, producing an increasing number of different products, maintaining complex sequencing software in batch execution often on mature control platforms, and reducing production costs. Automation is used to try to address these respective challenges.

Automating batch solutions in process industries is known to be a complex task. For an example ISA-88 compliant batch process, automating batch solutions generally requires developing of a physical model based on the equipment layout in the plant and also deriving a procedural model based on the process write-up for the batch product. ISA-88, shorthand for ANSI/ISA-88, is a standard which addresses batch process control by providing a consistent set of standards and terminology for batch control and defining the physical model, procedures, and recipes.

There are some commercially available batch design solutions such as the Honeywell EXPERION BATCH MANAGER that provide a single controller-based batch implementation architecture. The EXPERION BATCH MANAGER overcomes the above-described problems by providing a single controller platform for creating and completely executing all four levels of the ISA S88 procedural model. With the EXPERION BATCH MANAGER, changes to the batch system, modification in equipment and recipe configuration, and hardware addition/removal, can all be performed online without shutting down any element. The operator's view of the batch comes directly from the single controller and is not dependent on a batch server or on any single point of failure. Multiple EXPERION controllers behave as a single virtual controller. Because all batch functions are built into this batch system, there is no additional batch hardware or software needed.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize the process of defining the physical model and defining the procedural model for a batch process is subject to a user's experience and interpretation of the batch process standards (e.g., ISA-88) and the batch processes in association with the tools/functionalities that a standards compliant batch engineering system might provide. The batch engineering solutions provided by various batch engineering system vendors are also not identical and differ based on their particular interpretation of the batch standard and the functionalities/features adopted into the engineering tools and the control logic. Even for multiple sites manufacturing the same or similar products on similar batch engineering systems, dissimilarities in the equipment layout and recipes generally require a redesign of the batch process. Accordingly, there is no known relatively simple method to reuse an existing batch engineering system solution used at one manufacturing site as a plug-and-play at a different manufacturing site.

Disclosed batch design tools referred to herein as a ‘deCodeBatch’ tool solves the problem of conventional batch engineering systems that require a redesign of the batch process for each of the multiple sites manufacturing similar products on similar batch engineering systems. The deCodeBatch tool has a batch design algorithm which implements a simplified modular batch design method that enables reusing an existing batch process solution as a plug-and-play at different manufacturing sites.

Disclosed embodiments include a method of batch system design for batch processes run by a batch processing system including providing a piping and instrumentation diagram of the batch system and process write-ups of the batch processes as inputs to the deCodeBatch tool. The algorithm processes the inputs along with modular batch design concepts and a compliant batch standard to derive batch engineering system designs comprising a first batch engineering system design compliant with the batch standard including a physical model and procedural model. The batch engineering system designs include function blocks for implementation. The first batch engineering system design is modified based on received customer feedback by a system specific configuration generation block to generate system specific configurations in a form of master batch recipes, the function blocks and sequential function charts (SFC) ladder logistics. The system specific configurations are processed to generate a customized batch engineering system design.

### BRIEF DESCRIPTION OF THE DRAWINGS

FIG. 1 depicts the work flow for an example deCodeBatch tool showing the blocks for implementing the various work flow steps, according to an example embodiment.

FIG. 2 is a flow chart that shows steps in an example method of batch engineering system design for batch processes run by a batch processing system, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

In the below Table are some of the terms, acronyms, and abbreviations used within this Application.

| Abbreviation | Definition |
|---|---|
| Batch | Industrial Batch Automation Systems/Solutions of various |
| Engineering | Vendors such as Honeywell, Emerson, Yokogawa, |
| System | Siemens, Rockwell, and ABB. |
| SPI | SmartPlant Instrumentation |
| ISA | Instrumentation Society of America |
| S88 | shorthand for ANSI/ISA-88, which is a standard addressing |
| | batch process control |
| SAMA | Scientific Apparatus Makers Association |

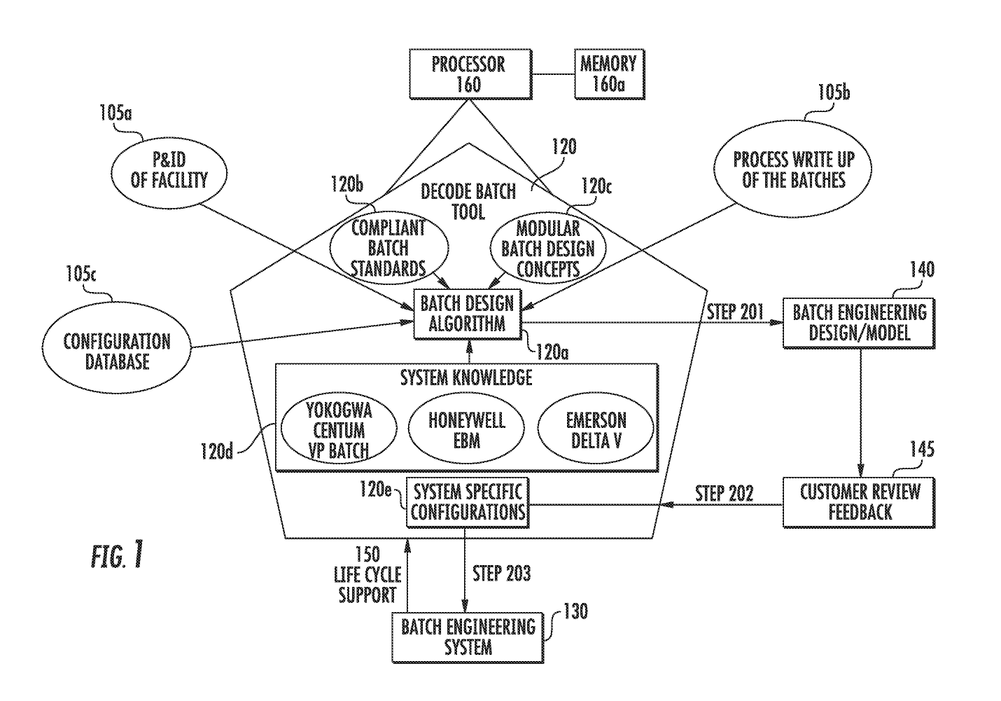

Disclosed deCodeBatch tools implement a vendor independent solution for industrial batch automation systems that enables batch designs to be generated with a minimum of engineering effort which inherently comply with a batch standard, such as S88. As used herein master recipes are recipes bound to a unit at the time of recipe configuration also referred to as a Unit-Based Recipe. A “unit” as used herein is a collection of associated control modules and/or equipment modules or other process equipment in which one or more major processing activities can be conducted, such as a reactor, blender, or mixer. Class-based recipes are not bound to a unit during recipe configuration. Instead, unit selection and binding (the physical association between a recipe and the unit) for class-based recipes happens during runtime. Class-based recipes can run on any identical unit (i.e., 2 or more units as defined above which have identical physical attributes can perform the same process function). To generate a class-based recipe or unit-based recipe the deCodeBatch tool generally receives the following 4 items of information as inputs regarding the customer' plant facility site:
1. A piping and instrumentation diagram/drawing (P&ID) of the plant facility. The P&ID of the facility is shown as 105a in FIG. 1 described below. The P&ID shows the interconnection of processing equipment and the instrumentation (controller and I/Os) used to control the process that can be in the form of an AutoCAD diagram, or an Instrument List with SPI plugins. A P&ID includes the major and minor flows, control loops and instrumentation. P&IDs are also called flowsheets. The P&ID of the facility is generally available information.
2. A process write-up of the respective batches, generally in the form of process flow diagrams (PFDs). The process write-up of the batch processes (batches) is shown as 105b in FIG. 1 described below. A site recipe is specific to a manufacturing site taking into consideration specific conditions or constraints of that site to manufacture a product. The process write-up 105b will generally be an unstructured sequence of operations that are executed to manufacture the final product. The process write-up 105b can be the same as the site recipe or derived from it such as SAMA-compliant PFDs.

SAMA diagrams are commonly used for the power industry to describe and document control strategies and systems designed for both industrial and utility boiler applications. PFDs are used in chemical and process engineering. These diagrams show the flow of chemicals and the equipment involved in the process. Generally, a PFD shows only the major equipment and does not show details as a PFD is a simplified version of the P&ID which shows only those equipment which are generally required for manufacturing the product. Finer details in the P&ID specific to various equipment, instrumentation/electrical/mechanical data are generally not captured in the PFD. A PFD is generally included because a PFD also provides an indication of how the material flow occurs through the various equipment before it is made into a product, which is more cumbersome using a P&ID.
3. The S88 (or other compliant batch process control standard, such as NAMUR, IEC61512-1) and modular batch design concepts. The compliant batch standards is shown as 120b and the modular batch design concepts is shown as 120c in FIG. 1 described below. Modular batch design concepts are in line with the models and terminology of the standard (e.g., S88 Modular Batch Automation (MBA)) where the batch design includes of a physical model and procedural model. The physical model includes a process cell, unit, equipment model and control model. The procedural model includes a phase, operation, unit procedure and procedure. The modular batch design needs a defining of the entire batch manufacturing process into the physical and procedure model in a modular way.
4. A system knowledge standard (e.g., ISA) compliant batch engineering system. As noted above the compliant batch standards is shown as 120b in FIG. 1, such as the S88 Standard. The system knowledge of batch engineering systems is shown in 120d in FIG. 1 described below. For example, 120d can comprise the Honeywell TOTALPLANT BATCH or HONEYWELL EXPERION BATCH MANAGER (EBM) which is shown in FIG. 1 along with YOKOGWA and EMERSON products as other examples for 120d. As described above, the HONEYWELL EBM is a commercially available single controller-based batch implementation architecture for creating and completely executing all four levels of the S88 procedural model. With the EXPERION BATCH MANAGER, changes to the batch system, modification in equipment and recipe configuration, and hardware addition/removal, can all be performed online without shutting down any element.

The information from these 4 items together are processed by the deCodeBatch tool to develop a high level batch design utilizing the various batch capabilities from item 3 (Capability of Batch Engineering system in a given standards compliant batch engineering system (in item 4). The high level batch design represents both the physical (equipment) model and the procedural model of the batch process. This high level batch design representation includes references to how and which function blocks can be utilized to implement the batch solution for that site with respect to the batch engineering system that is selected for the site.

The deCodeBatch tool is pre-programmed to identify equipment from the P&ID diagram (item 1) and correlate it with the function that it is going to perform. Here there is a correlating of equipment from the P&ID diagram with the process write-up/site specific recipe (item 2) within the entire batch process. The equipment is generally then further regrouped which involves classifying within the physical model as a process cell, unit, equipment model or control model and within the procedural model as a phase, operation, unit procedure or procedure which is modularization. The deCodeBatch tool indicates to the project engineer/customer how a batch in the selected system should be structured and how the various function blocks should be connected or sequenced per the language the batch engineering system supports.

The project engineer/customer is also able to modify the batch engineering design so long as it is complying with the tool batch standards. The project engineer/customer can access the deCodeBatch tool via a Web Server as a Web Client to review the batch engineering design generated by the deCodeBatch tool. Feedback from the project engineer/customer can be submitted back through the web client which can be processed and corrections or changes incorporated in the batch design. Once approved by the customer, the deCodeBatch tool generates the supported file types for the chosen batch engineering system that represent master recipes, function blocks, SFCs/ladder logics which would then be imported into the batch engineering system and worked upon further to complete the batch design implementation with minimal effort. The minimal further work can comprise a factory acceptance test/site acceptance test.

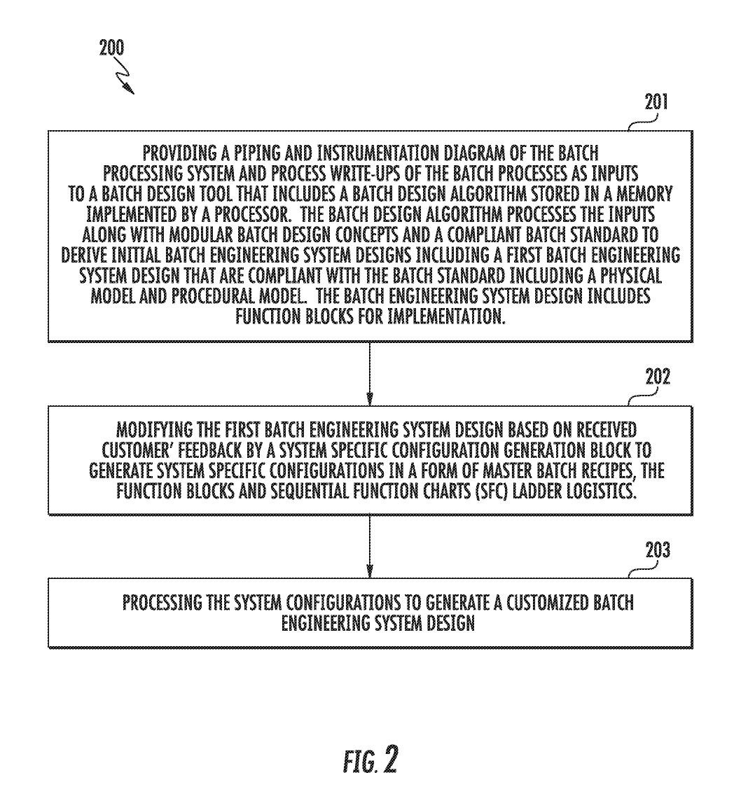

FIG. 1 depicts blocks for implementing the work flow for an example deCodeBatch tool 120 shown as steps 201, 202 and 203 in the flow chart in FIG. 2 described below. As described above, the deCodeBatch tool 120 can be implemented on a web server, or other implementation such as software as a service (SaaS). The deCodeBatch tool 120 includes a batch design algorithm 120a stored in a memory 160a implemented by a processor 160 used to derive the batch engineering design/model 140. Two of the inputs to the deCodeBatch tool 120, the P&ID of the facility 105a (item #1 above) and the process write-up of the batches 105b (item #2 above) are both shown as input feeds to the deCodeBatch tool 120, that are each input variables which can differ from site-to-site. The P&ID(s) of the facility 105a and site recipe/process write-up of the batches 105b can differ based on the product that is being manufactured and can differ from one plant to another plant. For example, a pharmaceutical drug developed by a drug company will use different process equipment/recipe as compared to a skin lotion that is manufactured by another company.

Another input feed to the deCodeBatch tool is shown as a configuration database 105c. Configuration database 105c which provides third party database(s) is optional, and is primarily used for expansion or competitive migration projects. The configuration database 105c has the structured third party database (in the form of tables/text providing a database schema/high level programs such as Pascal/C++) for an existing batch system configuration which serves as an additional input to the deCodeBatch tool 120 to derive the implemented batch engineering system design. In this case the batch design algorithm 120a has batch execution logic for processing the database schema from a third party batch engineering system stored in the configuration database 105c for logic for providing a customized database schema to enable expansion or competitive migration as additional input data along with PI&D 105a, process write up 105b, the modular batch design concepts 120c, and applicable compliant batch standard (e.g. S88) 120b to generate in step 201 a batch engineering design/model 140. Due to using the compliant batch standard 120b the resulting batch engineering design/model 140 is again inherently compliant with the applicable batch standard.

Regarding the P&ID of the facility 105a, this provides the physical layout of the equipment at the site. This is a needed input for the batch design algorithm 120a to derive the physical model. The process write-up of the batches 105b is a standardized template to capture the process write-up/site specific recipe which will serve as an input to derive the procedural model portion of the batch engineering design/model 140 of the batch process.

Regarding S88 standards as the compliant batch standard 120b and modular batch design concepts 120c, the S88 batch standards and concepts of modular batch design can be as defined by ISA. The design of the batch design algorithm 120a is in compliance to these standards. This can be common for all vendor batch design solutions systems.

Regarding the system knowledge compliant batch engineering systems 120d (shown as “system knowledge” in FIG. 1), the batch engineering capabilities of the vendor's compliant batch engineering system is utilized as another input to the batch design algorithm 120a. This enables the deCodeBatch tool 120 in step 1 to structure the physical model portion and the procedural model portion of the batch engineering design/model 140 in line with the selected batch engineering system (item 4). This component is also used to generate the final system specific configuration of the batch which can be directly imported into the batch engineering system 130.

Regarding the batch design algorithm 120a, the deCodeBatch tool 120 contains at its core a batch design algorithm 120a that processes the P&ID diagram of the facility 105a and process write-up of the batches 105b, along with the compliant batch standards 120b and modular batch design concepts 120c. The deCodeBatch tool 120 uses this information to derive a batch engineering design/model 140 that is inherently compliant with the compliant batch standards 120b. Based on the batch engineering system selected for the site by the customer the “deCodeBatch” tool 120 in step 201 generates a batch engineering design/model 140 including both the physical model and procedural model of the entire batch process.

The batch engineering design/model 140 is provided to the customer for customer' feedback 145 generally involving design/configuration changes which in step 202 is provided to the system specific configuration generation block 120e (shown as “system specific configurations” in FIG. 1) for modifying the batch engineering design/model 140 based on customer' feedback 145 and system knowledge 120d to generate system specific configurations in a form of master batch recipes, function blocks and SFC ladder logistics. In step 203 the system specific configurations received from the system specific configuration generation block 120e are processed to create batch execution logics realized through system knowledge 120d by the deCodeBatch tool 120 to generate the batch engineering design/model 140 for the batch engineering system 130.

The batch engineering system 130 is shown providing life cycle support 150 to the deCodeBatch tool 120. Regarding life cycle support 150, changes made to the actual (physical) batch engineering system 130 will be fed back to the batch design algorithm 120a to maintain an updated design for system specific configuration generation block 120e. Life cycle support 150 thus enables future expansions at the same site as one will have an up-to-date design in line with the actual system configuration.

FIG. 2 is a flow chart that shows steps in an example method 200 of batch system design for batch processes run by a batch processing system, according to an example embodiment. Step 201 comprises providing a P&ID diagram of the facility (batch processing system) and process write-up of the batches 105b as inputs to the deCodeBatch tool 120 that includes a batch design algorithm 120a stored in a memory implemented by a processor 160. The batch design algorithm 120a processes the inputs along with modular batch design concepts 120c and a compliant batch standard complaint batch standards 120b to derive initial batch engineering system designs (batch engineering design/model 140) including a first batch engineering system design that are compliant with the batch standard including a physical model and procedural model. The batch engineering system design includes function blocks for implementation.

Step 202 comprises modifying the first batch engineering system design based on received customer' feedback 145 by a system specific configuration generation block 120e to generate system specific configurations in a form of master batch recipes, the function blocks and SFC ladder logistics. Step 203 comprises processing the system specific configurations to generate a customized batch engineering system design for the batch engineering system 130.

The method 200 can further comprise automatically deriving test cases for factory acceptance tests and site acceptance tests from the customized batch engineering system design. A translation engine (software, part of the batch design algorithm 120a) reads the batch specifications and writes test steps involving driving certain inputs and reading the output changes and comparing it with fixed expected conditions related to the batch logic. Reading and writing the parameters from/to the process controller can be accomplished through a Control Data Access (CDA) protocol or through third party communication protocols such as Modbus, OPC or DLL based communication drivers.

The method can further comprise automatically updating the customized batch engineering system design using changes made directly on the batch engineering system 130, with changes such as to recipe structure, steps, parameters, or interlocks. Changes made to the actual batch engineering system 130 can be fedback to the batch design algorithm 120a to maintain an updated design for system specific configuration generation block 120e. This enables future expansions at the same site as one would have the up-to-date Design in line with the actual system configuration.

The method can further comprise intelligent translation of competitive databases to a batch solution provider specific batch engineering solution. A third party application or tool has the layout of a database (database schema) of another (e.g., a competitive) batch design system stored in the configuration database 105c. The batch design algorithm 120a interprets the database schema from the third-party database in the configuration database 105c and along with the other inputs described above (105a, 105b, 120b, 120c) converts it into a batch engineering design/model 140 (step 201) which can be further processed (step 202) to develop the schema that is loaded into the batch engineering system 130 (step 203).

The method can further comprise the batch design algorithm 120a generating batch execution logic for any batch engineering system. The deCodeBatch tool 120 applies for migration of 3^{rd} party systems as well as for Greenfield projects (projects without the need to consider any prior engineering configuration). As described above, in the case of competitive migration, configuration database 105c is included which provides the database schema from a stored third-party database of the third party batch engineering system. The batch design algorithm 120a interprets the database schema and along with the P&ID 105a, process write-ups 105b, compliant batch standards 120b along with the database schema from the third-party database in the configuration database 105c for creating a new batch design/model 140. The new batch design/model 140 is further processed (steps 202 and 203) to develop the schema for any batch engineering system.

Features of disclosed deCodeBatch tool 120 include the ability to interpret existing P&IDs 105a to help build a complete batch engineering design recipe comprising both the physical model and the procedural model into a distributed control system (DCS). The deCodeBatch tool 120 helps reduce engineering complexity and also maintain a design consistency across the complete project. Engineering costs can be significantly reduced with the usage of the deCodeBatch tool 120. The batch structure/recipe will be accessible to the customer early on in the project development life cycle, thus providing an opportunity to address concerns in customer' feedback 145 early rather than having to rework the design towards the end of the batch design cycle. The deCodeBatch tool 120 also creates consistent batch design solutions for similar products across multiple sites irrespective of the choice of vendor automated batch system being utilized.

Disclosed deCodeBatch tools 120 will find use in plants by providing batch process solutions that can be used to run industrial processes. Moreover, disclosed deCodeBatch tools 120 will provided the advantage of enabling the user to reuse an existing batch process solution as a plug-and-play at different manufacturing sites. Disclosed deCodeBatch tools 120 can be also used for creation of batch engineering design/model and batch execution logic for Greenfield projects, competitive replacement of known batch engineering systems, automated updates to the batch engineering design/model as and when batch execution logic is changed in the DCS system, automated derivation of test cases for factory acceptance and site acceptance tests to validate the engineering logic.

Disclosed embodiments are competitive replacements for known batch solutions since the re-engineering cost for batch engineering will be significantly reduced. Expansion projects at customer sites can be addressed in a cost effective manner since the redesign of the batch recipes (procedural model/and physical model) will be performed by disclosed algorithms 120a. A redesign of existing batch processes which are not already compliant to standards such as the ISA S88 standards can be achieved in an easier and more cost effective manner using disclosed embodiments.

Incorrect implementation of batch standards can be prevented through the usage of disclosed deCodeBatch tools thus ensuring that the site is close to 100% compliant the standard such as the ISA S88 Standard. The deCodeBatch tool creates consistent batch solutions for similar products across multiple sites irrespective of the choice of the automated batch system being used or the physical nature of the plant. As the batch structure/recipe will be accessible to the customer early on in the Project Development Life cycle, an opportunity to address concerns is provide to the customer early rather than having to rework the batch solution towards the end of the design cycle.

For sales, disclosed embodiments make the batch engineering design simpler which enables the project engineering group to design and deploy batch projects with far less complexity and expertise. Overall engineering costs are significantly less for batch projects thus enabling bidding for projects at a competitive cost. For project engineering, disclosed embodiments help project engineering teams come up with consistent/repetitive batch design solutions which can be compliant to the ISA S88 batch standards. Disclosed embodiments provide an intuitive way of designing a batch which does not need the User to be an expert on batch processes or ISA S88 Standards.

The User would have to only state its requirements through the process write-up and the deCodeBatch tool would process the information to provide a Batch Design in compliance to ISA S88 Standards. Overall engineering time to design and develop batch solutions on a batch engineering system will be considerably reduced since a large percentage of Batch Engineering will be done by the deCodeBatch tool. The deCodeBatch tool will help reduce engineering complexity and also maintain a design consistency across the complete project. Consistent configurations of batch solutions also enable easier trouble shooting and maintenance of the batch engineering system solution. This also enables tracking and reporting mechanisms to be more consistent.

### EXAMPLES

Disclosed embodiments are further illustrated by the following specific Examples, which should not be construed as limiting the scope or content of this Disclosure in any way.

An example use case described below is for a disclosed method is the reuse of an existing batch engineering system solution used at one manufacturing site as a plug-and-play at a different manufacturing site.

An example case for a Greenfield project can comprise the following:
a. The Project engineer obtains the P&ID of the facility 105a, and SPI data pertaining to the physical characteristics of the Site.
b. The Engineer also receives the process write-up of the batches 105b or site level recipe for the various products to be manufactured at the site.
c. The Engineer feeds in this information to a deCodeBatch Tool 120.
d. The batch design algorithm 120a within the deCodeBatch Tool 120 with create a ISA-S88 compliant modular batch design/model 140 based on the inputs that were provided to it and the DCS System that was selected for that site.
e. The batch engineering design/model 140 is accessible by the Customer for review through a web server/client approach.
f. The batch design algorithm 120a makes modifications to the batch design based on the customer' feedback 145.
g. Once the batch design is approved, the batch design algorithm 120a creates the Configuration Strategies for the chosen batch engineering system (e.g., DCS System) which can be directly imported into the batch engineering system 130.
h. Any changes made to the configurations/design directly in the batch engineering system 130 can be uploaded back into the deCodeBatch tool 120 so that the design can be kept updated.

An example use case for reusing a batch engineering solution can comprise the following:
a. The Project engineer obtains the updated Batch Engineering design from Plant-A which is already in production by uploading the batch configuration from the DCS System on Plant-A.
b. The deCodeBatch” Tool 120 Updates the batch design pertaining to the live configuration in the system.
c. The Project engineer then feeds the P&ID of the facility 105a and process write-up of the batches 105b or Site Level Recipe of the batches specific for the Plant-B to the “deCodeBatch” tool 120. There will be slight changes to the P&ID/Site Level Recipe specific to the site Plant-B.
d. Based on the DCS System being used at Plant-B, the deCodeBatch tool 120 creates a batch engineering design/model 140.
e. The batch engineering design/model 140 will be accessible by the Customer for review through a Web Server/Client approach.
f. The batch design algorithm 120a will make modifications to the Design based on the customer feedback 145.
g. Once the Design is approved, the batch design algorithm 120a will create the configuration strategies for the chosen batch engineering system 130 (e.g., DCS System) which can be directly imported into the batch engineering system 130.
h. Any changes made to the configurations/design directly in the batch engineering system 130 can be uploaded back into the deCodeBatch tool 120 so that the batch design can be kept updated.
i. The entire batch configuration from Plant-A possibly running on a particular batch engineering system 130 can be ported to Plant-B which can be on a different batch engineering system with a minimum of manual effort.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

1. A method of batch system design for batch processes run by a batch processing system, comprising;
providing a piping and instrumentation diagram of said batch processing system and process write-ups of said batch processes as inputs to a batch design tool that includes a batch design algorithm stored in a memory implemented by a processor, said algorithm processing said inputs along with modular batch design concepts and a compliant batch standard to derive batch engineering system designs including a first batch engineering system design compliant with said batch standard including a physical model and procedural model, said batch engineering system designs including function blocks for implementation;
modifying said first batch engineering system design based on received customer' feedback by a system specific configuration generation block to generate system specific configurations in a form of master batch recipes, said function blocks and sequential function charts ladder logistics, and
processing said system specific configurations to generate a customized batch engineering system design.

2. The method of claim 1, further comprising said batch processing system using said customized batch engineering system design to run a selected one of said batch processes.

3. The method of claim 1, further comprising reusing said customized batch engineering system design as a plug-and-play at a different manufacturing site compared to a site said batch engineering system design was designed for.

4. The method of claim 1, further comprising automatically deriving test cases for factory acceptance tests and site acceptance tests from said customized batch engineering system design.

5. The method of claim 1, further comprising automatically updating said customized batch engineering system design using changes made directly on said batch processing system.

6. The method of claim 1, further comprising said batch design algorithm interpreting a database schema of a third party database and converting said database schema into third party data that is used as additional data by said batch design algorithm for deriving said first batch engineering system design.

7. The method of claim 6, wherein said batch design algorithm further comprises converting said first batch engineering system design into batch execution logic for providing a customized database schema for a given existing batch engineering system design.

8. The method of claim 1, wherein said batch processing system is configured as a distributed control system (DCS).

9. A computer program product, comprising:
a data storage medium that includes program instructions executable by a processor to enable said processor to execute to implement a batch design tool that includes a batch design algorithm stored in said data storage medium for implementing a method of batch design for batch processes run by a batch processing system, said method comprising:
code for processing inputs including a piping and instrumentation diagram of said batch processing system and process write-ups of said batch processes, along with modular batch design concepts and a compliant batch standard to derive batch engineering system designs including a first batch engineering system design compliant with said batch standard including a physical model and procedural model, said batch engineering system designs including function blocks for implementation;
code for modifying said first batch engineering system design based on received customer' feedback by a system specific configuration generation block to generate system specific configurations in a form of master batch recipes, said function blocks and sequential function charts ladder logistics, and
code for processing said system specific configurations to generate a customized batch engineering system design.

10. The computer program product of claim 9, further comprising code for reusing said customized batch engineering system design as a plug-and-play at a different manufacturing site compared to a site said batch engineering system design was designed for.

11. The computer program product of claim 9, further comprising further code for automatically deriving test cases for factory acceptance tests and site acceptance tests from said customized batch engineering system design.

12. The computer program product of claim 9, further comprising code for automatically updating said customized batch engineering system design using changes made directly on said batch processing system.

13. The computer program product of claim 9, further comprising code for said batch design algorithm interpreting a database schema of a third party database and converting said database schema into third party data that is used as additional data by said batch design algorithm for deriving said first batch engineering system design.

14. The computer program product of claim 13, further comprising code for converting said first batch engineering system design into batch execution logic providing a customized database schema for a given existing batch engineering system design.
